(19) United States
(12) Patent Application Publication
(10) Pub. No.: US 2004/0136805 A1
(43) Pub. Date: Jul. 15, 2004

(54) Fastener for spanning a large gap

(76) Inventors: Rex Miller, Waterford, MI (US); Larry E. Carter, Upland, IN (US)

Correspondence Address: HARNESS, DICKEY & PIERCE, P.L.C., P.O. BOX 828, BLOOMFIELD HILLS, MI, 48303, US

(21) Appl. No.: 10/696,739

(22) Filed: Oct. 28, 2003

Related U.S. Application Data
(60) Provisional application No. 60/421,759, filed on Oct. 28, 2002.

(51) Int. Cl. F16B 39/284

(52) U.S. Cl. 411/112

(57) ABSTRACT

A cage nut assembly is provided having a nut with a body and depending base. The body and base define a bore through the body and base. A cage is disposed about at least a portion of the nut. The cage enables a limited range of movement for the nut within the cage and defines an aperture coaxial with the bore.

### CROSS-REFERENCE TO RELATED APPLICATIONS

This application claims the benefit of U.S. Provisional Application No. 60/421,759, filed on Oct. 28, 2002. The disclosure of the above application is incorporated herein by reference.

### FIELD OF THE INVENTION

The present invention relates generally to a fastener and, more particularly, to an encaged, threaded fastener.

### BACKGROUND OF THE INVENTION

With ever increasing design demands, flexibility and adaptivity of unibody construction is increasingly required in order to provide vehicles that meet broader customer needs. Increases in the number of components and structures which are coupled to the unibody construction have led designers to consistently add threaded fasteners to the unibody frame. Variation in manufacturing tolerances require that the fastener couple to the unibody frame in a way which allows a degree of positional adjustment during final assembly. This positional adjustment is provided by using a female fastener, which is an encaged fastener. Typically, this takes the form of a nut encaged in a structure that is attached to the inner body frame. The cage is configured so as to provide the nut with a range of movement so that when a component is coupled to the frame, the alignment of the component and frame can be adjusted until they meet manufacturing standards.

Very large variations in vehicle manufacturing tolerances, however, significantly increase the possible loading on fasteners, thus requiring larger and heaver fastening systems be used. This increase in fastener weight leads vehicle manufactures to make costly weight decreases in other portions of the vehicle to maintain government fuel efficiency standards. Accordingly, a need exists for a fastener with decreased weight and improved strength.

### SUMMARY OF THE INVENTION

The present invention provides a caged fastener assembly. In another aspect of the present invention, the fastener is a cage nut assembly which has a nut with a body and depending base. A further aspect of the present invention provides a cage disposed about at least a portion of the nut. In yet another aspect of the present invention, a transition thickness in a fastener is greater than a body and/or base thickness.

Advantages of the present invention over conventional constructions include an ability to span large gaps without nut deformation which reduces part failures and improves part reliability. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The greatest advantage of the present invention will become apparent to one skilled in the art upon reading the following specification and by reference to the drawings in which:

FIG. 1 is a perspective view of the cage nut fastener in its unassembled condition according to the principles of the present invention;

FIG. 2 is a perspective view of the cage nut fastener of the present invention in its assembled configuration;

FIG. 3a is a cross-sectional view of the cage nut fastener in FIG. 2, taken along line 3-3 of FIG. 2, showing the first embodiment for the through bore of the cage nut fastener of FIG. 1;

FIG. 3b is a cross-sectional view, like that of FIG. 3a, showing an alternative embodiment cage nut fastener;

FIG. 4 is a perspective view of the preferred embodiment of a cage nut fastener in its unassembled condition according to the principles of the present invention;

FIG. 5 is a perspective view of the cage nut fastener of FIG. 4 in its assembled configuration; and

FIG. 6 is a cross-sectional view of the cage nut fastener in FIG. 5 showing the relationship of the fasteners and attached parts.

### DETAILED DESCRIPTION OF THE PREFERRED EMBODIMENT

The following description of the preferred embodiment is merely exemplary in nature and is in no way intended to limit the invention, its application, or uses.

The present invention is generally related to a fastener for use in applications which require a fastener to span large unsupported sections with minimal deflection. In this regard, the fastener will be described in the context of a cage nut fastener for use in joining sections of an automotive vehicle component, such as a truck bed or, alternately, an engine mount. However, it is to be understood that the principles embodied herein are equally applicable to the joining of other types of structures. In addition, it is to be understood that the fastener disclosed may function according to the principles of this invention with or without a cage, although various advantages of the present invention may not be achieved.

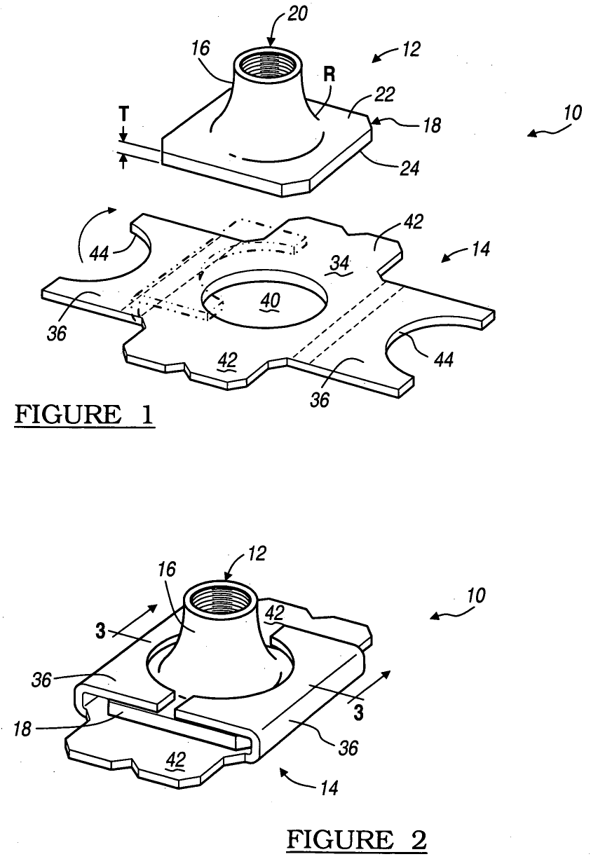

With reference now to FIGS. 1-3b, a first alternate embodiment of a cage nut fastener 10 is shown. The cage nut fastener 10 includes a nut 12 and a cage 14. The nut 12 has a main body 16, a base 18 and a through bore 20 extending through the main body 16 and the base 18. The main body is generally conical in nature. The height H of the main body 16 may vary depending on the particular application, but is generally 1.5 to 2.5 times the thickness T of the base 18. The base 18 of the nut 12 is generally square in shape, however any suitable shape may be used. The base 18 has a upper surface 22 and a bottom surface 24. The main body 16 mates with the top surface 22 of the base 18 via a defined concave radius R. In an assembled state, both the upper surface 22 and the bottom surface 24 contact the cage 14 as shown in FIG. 2.

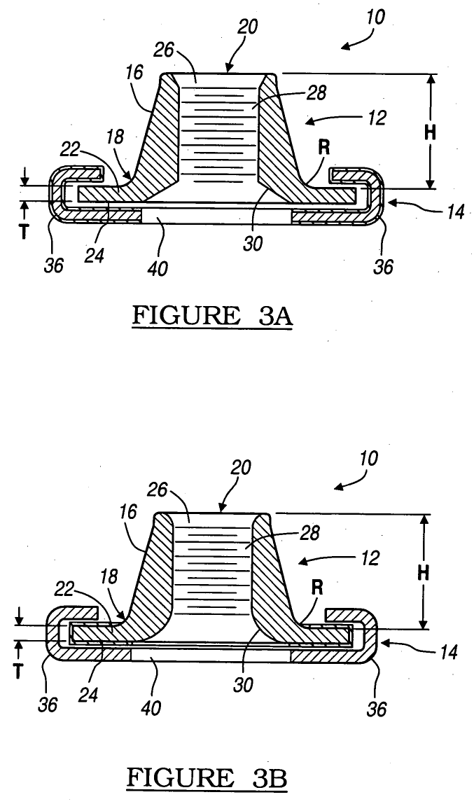

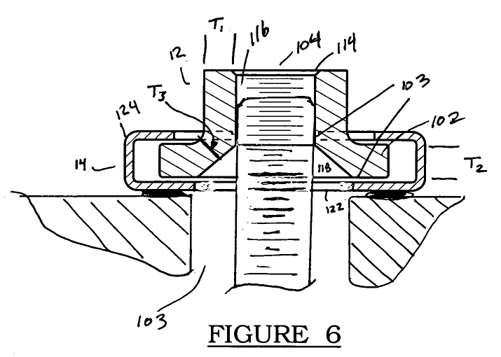

With reference now to FIGS. 3a and 3b, the through bore 20 is shown in greater detail. It will be understood that the through bore 20 described herein is adaptable to any type of fastener, and thus the principles disclosed herein are merely exemplary in nature. The through bore 20 can be characterized by three sections: a top countersink 26, a middle threaded section 28 and bottom countersink 30. The top countersink 26 ensures the bottom of the fastener does not extend beyond the main body 16. The middle threaded section 28 has threads as dictated by the particular fastener employed. The bottom countersink 30 facilitates the alignment of a fastener therethrough and further assists in the subsequent alignment of the joining surfaces (FIG. 6). The bottom countersink 30 is proportionally larger than the top countersink 26 and may be defined by either an angled surface 32a as shown in FIG. 3a or a radius 32b as shown in FIG. 3b.

As best shown in FIG. 1, the cage 14 includes a body 34 with two flanges 36 and an upper surface 38. The body 34 defines a central aperture 40. The aperture 40 has a slightly larger diameter than the diameter of the bottom countersink 30 of the nut 12 to facilitate the receipt of a fastener therein. The body 34 further includes a pair of attachment points 42 which, in this embodiment, have an identical configuration. The configuration of the attachment points 42 can be adapted to suit the workpiece, as will be shown in the second embodiment. The attachment points 42 enable the cage nut fastener 10 to be affixed to a workpiece via any suitable means, such as, for example, welding, bolting, adhesion or riveting.

The flanges 36 of the cage 14 serve to retain the nut 12. The flanges 36 have cutouts 44 which correspond generally to the shape of the main body 16 of the nut 12. The cutouts 44 are sized to restrict the movement of the nut 16 therein. In particular, as best shown in FIGS. 3a and 3b, the cutouts 44 permit the nut 12 to move slightly away from the upper surface 38 of the cage 14 and also enable slight planar movement of the nut 12 generally parallel to the upper surface 38.

With reference now to FIG. 2, the cage nut fastener 10 is shown assembled. In order to assemble the nut 12 with the cage 14, the through bore 20 of the nut 12 is co-axially aligned with the aperture 40 of the cage 14. Next, the flanges 36 of the cage 14 are folded over the upper surface 38 of the base 18 of the nut 12.

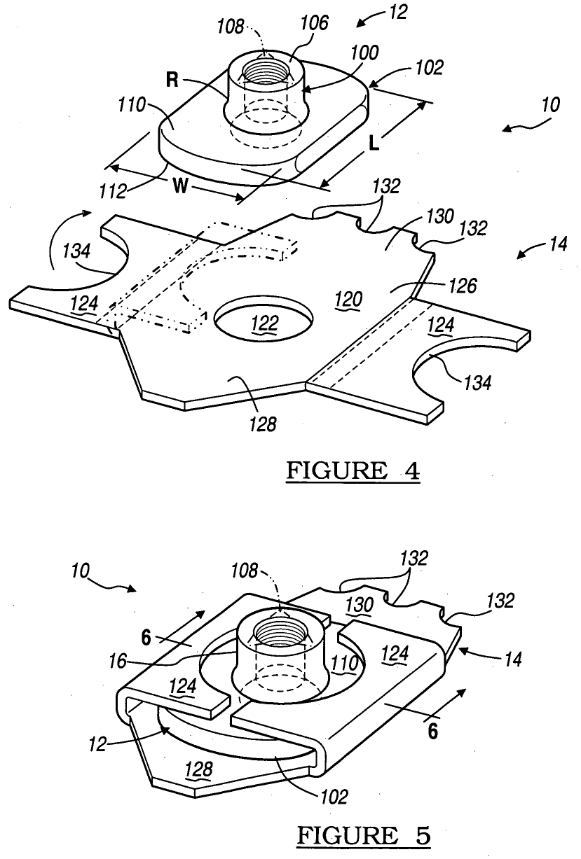

A second alternate embodiment of the cage nut fastener 10 is shown in FIGS. 4-6, wherein common reference numbers are utilized herein. The alternative embodiment is based on the previous embodiment, including a nut 12 and a cage 14. Similar to the embodiments disclosed in FIGS. 1-3b the nut 12 and the cage 14 are configured to span a large gap or hole 103 formed in an automotive component, which will be described in detail below.

In the alternative embodiment, the single piece nut 12 includes a main body 100, a base 102 and a through bore 104 extending through both the main body 100 and the base 102. Coupling the main body 100 and base 102 is a transition portion 101. The main body 100 generally extends 10.7 mm to 12.6 mm above the base 102 with an outer diameter of 21.4 mm to 24.0 mm. The main body 100 is generally cylindrical, with an upper surface 106. The upper surface 106 may optionally include a plurality of triangular grooves 108 as shown by phantom lines. These triangular grooves 108 provide a coefficient of friction to ensure that the nut 12 is properly torqued.

The base 102 is generally oval in shape, however any shape suitable for the desired application would be within the scope of the present invention. The base 102 is has a width W of 35.1 mm to 39.7 mm and a length L of 43.2 mm to 48.3 mm. The base 102 has a top surface 110 and a bottom surface 112. The main body 100 mates with the top surface 110 of the base 102 via a defined concave radius R at the transition portion 101. Both the top surface 110 and the bottom surface 112 contact the cage 14 as shown in FIG. 5.

As shown in FIG. 6, the through bore 104 can be characterized by three sections: a top countersink 114, a middle threaded section 116 and a bottom countersink 118. The top countersink 114 has a diameter between 13.5 mm to 14.9 mm. The top countersink ensures the bottom of the fastener does not extend beyond the upper surface 106 of the main body 100. The middle threaded section 116 has threads as dictated by the particular fastener employed. Specifically, the number of threads and size of the threads is a function of the proof load required to meet a particular fastener class e.g. a Class 10 fastener.

The bottom countersink 118 has a diameter which is preferably equal to diameter of the hole 103 formed in the component. The bottom countersink 118 has a diameter between 23.47 mm to 26.67 mm at an angle ranging between about 90 degrees and about 125 degrees. The specific angle of the countersink is a function of the diameter of the hole 103 in the component and the diameter of the threaded through bore 104. The bottom countersink 118 which can be flat, concave or convex, facilitates the alignment of a fastener therethrough and further assists in the subsequent alignment of the joining surfaces (shown in FIG. 6).

The main body 100 has a minimum wall thickness T1 can be held constant throughout the length of the main body 100. The base 102, which is generally planar, has a minimum wall thickness T2 that can be held constant throughout the length of the base 102. The transition portion 103 has a minimum wall thickness T3 can be held constant throughout the length of the transition portion 103. The minimum thickness T3 of the transition portion 103 can be greater than or equal to the minimum thickness T1 of the body 100 or can be greater than or equal to the minimum thickness T2 of the base 102. Preferably, the minimum thickness T3 of the transition portion 103 is greater than or equal to both the minimum thickness T1 of the body 100 and is greater than or equal to the minimum thickness T2 of the base 102. Optionally, the wall minimum thickness T1 of the body, the base T2 and the transition portion T3 are substantially constant throughout.

With reference now to FIG. 4, the cage 14 has a body 120 defining a central aperture 122 and a pair of flanges 124. The aperture 122 has a slightly larger diameter than the diameter of the bottom countersink 118 of the nut 12 to facilitate the receipt of a fastener therein. The body 120 has an upper surface 126 which contacts the nut 12. The body 120 is further characterized by a first attachment point 128 and a second attachment point 130. The first attachment point 128 is triangular in shape, while the second attachment point 130 is defined by three curved cutouts 132. Both the first and second attachment points 128, 130 can be configured to mate with the workpiece (FIG. 6), and may be adapted for any type of suitable fastening means, such as, for example, welding, adhesion, bolting or riveting.

The pair of flanges 124 each have a cutout 134 which enable the flanges 124 to mate substantially with the main body 100 of the nut 12. The flange cutouts 134 retain the nut 12 in the cage 14 and are sized to restrict the movement of the nut 12 within the cage 14. In particular, as best shown in FIG. 5, the cutouts 134 permit the nut 12 to move slightly away from the upper surface 126 of the cage 14 and also enable slight planar movement of the nut 12 generally parallel to the upper surface 126. The movement of the nut 12 within the cage 14 provides for easier alignment of the nut 12 with a fastener (FIG. 6).

With reference now to FIG. 5, the cage nut fastener 10 is shown assembled. In order to assemble the nut 12 with the cage 14, the through bore 104 of the nut 12 is co-axially aligned with the aperture 122 of the cage 14. Next, the flanges 124 of the cage 14 are folded over the upper surface 126 of the base 102 of the nut 12.

The nut 12 as described in either the first or second embodiment is a Class 10 or higher fastener. In this regard, a nut class is defined by its proof load in mega-Pascal (MPa) divided by 10. The shape of the main body 16, 100, either conical or cylindrical, in conjunction with the transition portion, aids in reducing the weight of the nut 12 without significantly reducing the overall class or bearing strength of the nut 12. The nut 12 may be formed by either cold or hot forming processes and is preferably manufactured from medium carbon steels (1022-1050), but may also be produced from low carbon steels (1008-1010). The nut 12 can also be optionally heat treated.

The description of the invention is merely exemplary in nature and, thus, variations that do not depart from the gist of the invention are intended to be within the scope of the invention. For example, while a separate specific cage is shown, it is envisioned that a suitable structure, such as an inverted cage can be used. Additionally, the any structure which limits the range of movement of the nut with respect to a large gap or hole defined in the structure is envisioned. This specifically includes structures defined by or on the surface of the component the nut is coupled to. Such variations are not to be regarded as a departure from the spirit and scope of the invention.

What is claimed is:

1. A fastener assembly comprising:
a nut having a generally cylindrical body;
a base and a transition portion coupling the base to the body, the nut having a bore, the base having a base minimum thickness, and the transition portion having a transition minimum thickness greater than or equal to the minimum base thickness; and
a member operably allowing some movement of the nut associated therewith but limiting the movement of the nut.

2. A cage nut assembly comprising:
a nut having a body, a depending base and a transition portion coupling the base to the body, the body and base defining a bore, the body having a body minimum thickness, and the transition portion having a transition minimum thickness greater than or equal to the body minimum thickness; and
a cage disposed about at least a portion of said nut, wherein the cage provides a limited range of movement of the nut within the cage and defines an aperture at least partially aligned with the bore.

3. An automotive vehicle assembly comprising:
an automotive vehicle component;
a nut having a body and depending base and a transition portion coupling the base to the body, the body and base defining a bore through the body and base, the base having a base minimum thickness the body having a body minimum thickness, the transition portion having a minimum thickness greater than or equal to the body minimum thickness and greater than or equal to the base minimum thickness; and
a cage disposed about at least a portion of said nut, wherein the cage provides a limited range of movement of the nut within the cage, the cage being attached to the component.

4. The automotive vehicle assembly in accordance with claim 3 wherein the nut is a class 10 fastener.

5. The automotive vehicle assembly in accordance with claim 3 wherein the nut is a medium carbon steel.

6. The automotive vehicle assembly in accordance with claim 3 wherein the body comprises a planar base and wherein the cage defines a pair of flanges which covers at least a portion of the base.

7. The automotive vehicle assembly in accordance with claim 3 wherein the body has an exterior surface which is generally cylindrical in shape, the exterior cylindrical surface mates with an upper surface of the base, the interface of the exterior cylindrical surface and the upper surface is a defined concave radius; and wherein the nut defines a through bore, said through bore having a threaded region and at least one countersink.

8. The automotive vehicle assembly in accordance with claim 3 wherein the body has an exterior surface which is generally cylindrical in shape, the exterior cylindrical surface mates with an upper surface of the base, the interface of the exterior cylindrical surface and the upper surface is a defined concave radius; and wherein the nut defines a through bore, said through bore having a threaded region and at least one countersink.

9. The automotive vehicle assembly in accordance with claim 3 wherein the wall minimum thickness of the base, the body and the transition portion are substantially constant throughout.

10. A fastener comprising:
a one piece nut having a body and depending base, and a transition portion which couples the body and the base, the depending base having a base minimum thickness, the body and base defining a bore; and
wherein the minimum wall thickness of the transition portion is greater than the minimum thickness of the base.

11. The fastener of claim 10 further comprising a cage having an upper surface and two pair of flanges bent to enclose at least a portion of the base.

12. The fastener of claim 10 wherein the base is disposed on the upper surface of the cage.

13. The fastener of claim 10 wherein the bore comprises a convex countersink surface.

14. The fastener of claim 10 wherein the bore comprises a flat countersink surface.

15. The fastener of claim 10 wherein the nut has a proof load of at least 100 mega-pascal.

16. A fastener comprising:
a nut having a body;
a transversely extending base; and
a transition portion, the body and base defining a bore therethrough, wherein a wall minimum thickness of the transition portion is greater than or equal to a minimum thickness of the base and greater than or equal to the minimum thickness of the body.

17. A fastener comprising:
a nut having a body and depending base and transition portion, the body and base defining a bore, wherein a minimum wall thickness of the transition portion is greater than a minimum thickness of the body.

18. The fastener of claim 17 further comprising a cage having an upper surface and two pair of flanges bent to enclose at least a portion of the base.

19. The fastener of claim 18 wherein the base is disposed on the upper surface of the cage.

20. The fastener of claim 17 wherein the bore comprises a convex countersink surface.

21. The fastener of claim 17 wherein the bore comprises a flat countersink surface.

22. The fastener of claim 17 wherein the body is a cylinder.

23. The fastener of claim 22 wherein the cylinder is tapered cylinder.

24. A fastener for coupling to an automotive body, said body defining a hole having a first diameter, the fastener comprising:
a body defining a threaded bore therethrough, said threaded bore having a flat countersink having a first outer diameter which is greater than or equal to the first diameter, the flat countersink being configured to guide threaded fasteners into the threaded bore.

25. The fastener of claim 24 further comprising a member for regulating the movement of the fastener with respect to the hole.

26. The fastener of claim 25 wherein the member for regulating movement of the fastener is a cage having an upper surface and a pair of flanges configured to enclose at least a portion of said body.

27. The fastener of claim 25 wherein the member for regulating movement of the fastener is defined on the automotive component.

28. The fastener of claim 25 wherein the body is a class 10 fastener.

29. The cage fastener of claim 25 wherein the body comprises a planar base and wherein the means for regulating movement of the fastener covers at least a portion of the base.

30. The cage fastener of claim 24 wherein the body has an exterior surface which is generally cylindrical in shape, the exterior cylindrical surface mates with an upper surface of the base, and the interface of the exterior cylindrical surface and the upper surface is a defined concave radius.

31. The cage fastener of claim 30 wherein the bore comprises a flat countersink surface.

32. The cage fastener of claim 30 wherein the body is formed by a hot forming process.

33. The cage fastener of claim 30 wherein the body is formed by a cold forming processes.

34. The cage fastener of claim 30 wherein the body is heat treated.

35. The cage fastener of claim 30 wherein the wall thickness of the body is substantially constant throughout.

36. A fastener construction for coupling a fastener to component, said component defining a hole having a first diameter, the fastener construction comprising:
a body defining a threaded bore therethrough, said threaded bore having a having a second radius and countersink having a first outer radius smaller than or equal to the first diameter, the countersink being configured to guide threaded fasteners into the threaded bore;
a depending base and a transition portion coupling the base to the body, the base defining a bore coaxial to the threaded bore, the base having a base minimum thickness and the body having a body minimum thickness, the transition portion having a transition minimum thickness greater than or equal to the body minimum thickness and the base minimum thickness;
a fastener disposed through the hole and within a portion of the threaded bore; and
a means for regulating the movement of the body with respect to the hole.

37. The fastener construction of claim 36, further comprising a member which regulates the movement of the depending base with respect to the hole.

38. The fastener construction of claim 36 wherein the member has an upper surface and a pair of flanges configured to enclose at least a portion of said body.

39. The fastener construction of claim 36, wherein the member is defined on the component.

40. The fastener construction of claim 36, wherein the body is converted to a Class 10 fastener by hot forming operations.

41. The fastener construction of claim 36 wherein the base is planar and wherein the member covers at least a portion of the base.

42. The fastener construction of claim 36 wherein the body has an exterior surface which is generally cylindrical in shape, the exterior cylindrical surface mates with an upper surface of the base, and counter bore is a defined convex radius.

43. The fastener construction of claim 36 wherein the bore comprises a flat countersink surface.

44. The fastener construction of claim 36 wherein the body is formed by a hot forming process.

45. The fastener construction of claim 36 wherein the body is formed by a cold forming processes.

46. The fastener construction of claim 36 wherein the body is heat treated.

47. The fastener construction of claim 36 wherein the minimum wall thickness of the body is substantially constant throughout.

48. A method of forming a fastener comprising:
hot forming a nut having a cylindrical body with an integral base, further forming a transition portion between the base and the body, the transition portion having a thickness which is greater than a thickness of the body; and
forming a cage about the nut.
